(19) United States
(12) Patent Application Publication
(10) Pub. No.: US 2015/0220438 A1
(43) Pub. Date: Aug. 6, 2015

(54) DYNAMIC HOT VOLUME CACHING

(71) Applicant: NetApp, Inc., Sunnyvale, CA (US)

(72) Inventors: Mardiros Chakalian, San Jose, CA (US); Darrell Suggs, Raleigh, NC (US); Robert Hyer, JR., Seven Fields, PA (US)

(73) Assignee: NetApp, Inc., Sunnyvale, CA (US)

(21) Appl. No.: 14/172,699

(22) Filed: Feb. 4, 2014

(51) Int. Cl. G06F 12/08

(52) U.S. Cl. CPC G06F 12/0831; G06F 2212/621

(57) ABSTRACT

Examples described herein include a computer system, implemented on a node cluster including at least a first node and a second node. The computer system monitors data access requests received by the first node. Specifically, the computer system monitors data access requests that correspond with operations to be performed on a data volume stored on the second node. The system determines that a number of the data access requests received by the first node satisfies a first threshold amount and, upon making the determination, selectively provisions a cache to store a copy of the data volume on the first node based, at least in part, on a system load of the first node.

### TECHNICAL FIELD

Examples described herein relate to computer storage networks, and more specifically, to a system and method for detecting and caching hot volumes in a computer storage network.

### BACKGROUND

Data storage technology over the years has evolved from a direct attached storage model (DAS) to using remote computer storage models, such as Network Attached Storage (NAS) and Storage Area Network (SAN). With the direct storage model, the storage is directly attached to the workstations and applications servers, but this creates numerous difficulties with administration, backup, compliance, and maintenance of the directly stored data. These difficulties are alleviated at least in part by separating the application server/workstations form the storage medium, for example, using a computer storage network.

A typical NAS system includes a number of networked servers (e.g., nodes) for storing client data and/or other resources. The servers may be accessed by client devices (e.g., personal computing devices, workstations, and/or application servers) via a network such as, for example, the Internet. Specifically, each client device may issue data access requests (e.g., corresponding to read and/or write operations) to one or more of the servers through a network of routers and/or switches. Typically, a client device uses an IP-based network protocol, such as Common Internet File System (CIFS) and/or Network File System (NFS), to read from and/or write to the servers in a NAS system.

Conventional NAS servers include a number of data storage hardware components (e.g., hard disk drives, processors for controlling access to the disk drives, I/O controllers, and high speed cache memory) as well as an operating system and other software that provides data storage and access functions. However, even with a high speed internal cache memory, the access response time for NAS servers continues to be outpaced by the faster processor speeds in the client devices, especially when a particular server is servicing multiple client devices at the same time. Furthermore, each client device connects to a data storage cluster through a particular server in the cluster (e.g., via the server's IP address), even though that server may not contain the actual data volume that the client intends to access. This can cause significant inter-node traffic and reduces overall system performance.

### SUMMARY

This Summary is provided to introduce in a simplified form a selection of concepts that are further described below in the Detailed Description. This summary is not intended to identify key features or essential features of the claimed subject matter, nor is it intended to limit the scope of the claimed subject matter.

In an aspect, a computer system performs operations that include monitoring data access requests received by a first node of a node cluster. The data access requests correspond with operations to be performed on a data volume stored on a second node of the node cluster. The computer system further determines that a number of the data access requests received by the first node satisfies a first threshold amount. The first threshold amount may correspond to a threshold percentage of the data access requests representing read operations. More specifically, the first threshold amount may correspond to a threshold percentage of the data access requests representing read operations for a particular set of data in the data volume. In some aspects, the threshold percentage corresponds to 95% of a total number of the data access requests received during a predetermined period. Upon determining that the number of data access requests satisfies the first threshold amount, the computer system selectively provisions a cache to store a copy of the data volume on the first node based, at least in part, on a system load of the first node.

The system load may include an amount of processor headroom available for the first node and/or an amount of aggregate headroom available for each aggregate associated with the first node. In some aspects, the computer system is to provision the cache if the amount of processor headroom exceeds a first threshold. Specifically, the computer system may provision the cache by first selecting an aggregate on the first node to host the cache. For example, the computer system may select the host aggregate based on the amount of aggregate headroom available for each aggregate associated with the first node. In some aspects, the computer system selects a host aggregate having an amount of aggregate headroom at or above a second threshold.

In still another aspect, the computer system may detect a cache request from the second node. The cache request indicates that the data volume stored by the second node is causing a system load of the second node to exceed a threshold load amount. Furthermore, the cache request may indicate a number of data access requests received by the second node that are associated with the data volume stored on the second node. In some aspects, the computer system may selectively provision the cache in response to: (i) determining that the number of data access requests received by the first node satisfies the first threshold amount, and (ii) detecting the cache request from the second node. The computer system may further analyze the cache request to determine whether the number of data access requests received by the second node exceeds the number of data access requests received by the first node over a given period. In some aspects, the computer system may selectively provision the cache only upon determining that the number of data access requests received by the second node exceeds the number of data access requests received by the first node.

Still further, some aspects described herein include a system for de-provisioning a cached volume in a node cluster. For example, the computer system may subsequently de-provision the cache used to store the copy of the data volume on the first node if such caching does not meet certain performance parameters.

In some aspects, the computer system may determine an updated system load of the second node, after provisioning the cache on the first node. The computer system may then determine whether to de-provision the cache based, at least in part, on the updated system load. For example, the cache may be de-provisioned if the updated system load is not at least a threshold improvement over the system load of the second node prior to provisioning the cache on the first node. The cache may also be de-provisioned if less than 80% of the data access requests received by the first node represent read operations. Still further, the computer system may de-provision the cache if all data access requests received by the node cluster, that are associated with the data volume stored on the second node, are processed by the first node.

The computer system may further detect a subsequent cache request from the second node indicating that another data volume is causing a system load of the second node to exceed a threshold load amount. Thus, in some aspects, the computer system may de-provision the current cache to enable a new cache to be provisioned for the other data volume.

Selectively provisioning (and de-provisioning) caches to store copies of a data volume enables the overall system load of a node cluster to be distributed across multiple nodes. Furthermore, aspects herein provide a mechanism for detecting “hot volumes” that contribute to load imbalances among the nodes of a node cluster, and identifying candidate nodes for storing locally-cached copies of the hot volumes in order to alleviate such load imbalances.

### BRIEF DESCRIPTION OF THE DRAWINGS

FIG. 1 illustrates a data storage system with dynamic hot volume caching, in accordance with some aspects.

FIG. 2 illustrates a cache configurator that is operable to provision and de-provision hot volume caches, in accordance with some aspects.

FIG. 3 illustrates an exemplary resource-usage model of a CPU that may be implemented in one or more nodes of a data storage system according to present aspects.

FIG. 4 illustrates an exemplary resource-usage model of a data store that may be implemented in one or more nodes of a data storage system according to present aspects.

FIG. 5 illustrates a method for dynamically caching hot volumes, in accordance with some aspects.

FIG. 6 illustrates a more detailed aspect of a method for dynamically caching hot volumes.

FIG. 7 illustrates a method for detecting hot volumes on a current node, in accordance with some aspects.

FIG. 8 illustrates a method for selecting an aggregate to host a cached volume, in accordance with some aspects.

FIG. 9 illustrates a method for de-provisioning a cached volume in order to cache a hotter volume, in accordance with some aspects.

FIG. 10 is a block diagram that illustrates a computer system upon which aspects described herein may be implemented.

### DETAILED DESCRIPTION

Examples described herein include a computer system to replicate a data volume in a node cluster in presence of data access requests which may place a heavy burden on system load by causing significant inter-node traffic.

As used herein, the terms “programmatic”, “programmatically” or variations thereof mean through execution of code, programming or other logic. A programmatic action may be performed with software, firmware or hardware, and generally without user-intervention, albeit not necessarily automatically, as the action may be manually triggered.

One or more aspects described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component can exist in a hardware component independently of other modules/components or a module/component can be a shared element or process of other modules/components, programs or machines. A module or component may reside on one machine, such as on a client or on a server, or may alternatively be distributed among multiple machines, such as on multiple clients or server machines. Any system described may be implemented in whole or in part on a server, or as part of a network service. Alternatively, a system such as described herein may be implemented on a local computer or terminal, in whole or in part. In either case, implementation of a system may use memory, processors and network resources (including data ports and signal lines (optical, electrical etc.)), unless stated otherwise.

Furthermore, one or more aspects described herein may be implemented through the use of instructions that are executable by one or more processors. These instructions may be carried on a non-transitory computer-readable medium. Machines shown in figures below provide examples of processing resources and non-transitory computer-readable mediums on which instructions for implementing one or more aspects can be executed and/or carried. For example, a machine shown in one or more aspects includes processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and tablets) and magnetic memory. Computers, terminals, and network-enabled devices (e.g. portable devices such as cell phones) are all examples of machines and devices that use processors, memory, and instructions stored on computer-readable mediums.

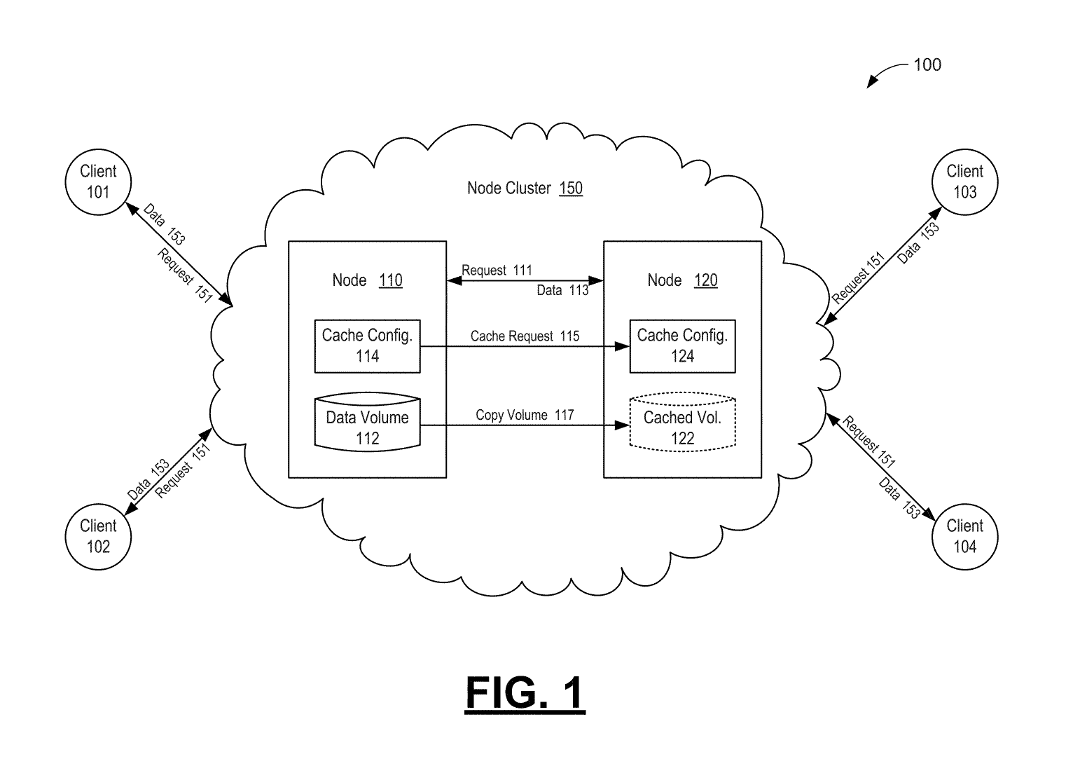

FIG. 1 illustrates a data storage system 100 with dynamic hot volume caching, in accordance with some aspects. The system 100 includes a number of client terminals 101-104 coupled to a node cluster 150. It should be noted that the node cluster 150 is shown to include two nodes 110 and 120 for simplicity, only, and may include fewer or more nodes in other aspects. The client terminals 101-104 may send data access requests 151 to and/or receive data 153 from the node cluster 150 using a network-based protocol such as, for example, Common Internet File System (CIFS) or Network File System (NFS). Each data access request 151 corresponds to a read or write operation to be performed on a particular data volume stored in the node cluster 150. Upon connecting to the node cluster 150, each client terminal 101-104 is assigned a unique Internet Protocol (IP) address which is associated with a particular server node (e.g., node 110 or 120).

It should be noted that each client terminal 101-104 is typically assigned an IP address independently of the data volume that client terminal is attempting to access. For example, client terminal 101 may be assigned an IP address for node 120, even though the data access request 151 transmitted by the client terminal 101 may identify the data volume 112 stored on node 110. The server node assigned to a particular client terminal serves as that client terminal's access point to the entire node cluster 150. Thus, upon receiving the data access request 151 from the client terminal 101, node 120 may forward a corresponding request 111 to node 110 to perform the requested operation on the data volume 112. If the request 151 corresponds to a read operation, node 110 may respond to the request 111 by transmitting the requested data 113 back to node 120, which then forwards the data 153 to the requesting client terminal 101.

Inter-node traffic (e.g., request 111 and/or data 113) may reduce the overall performance of the data storage system 100, since the nodes 110 and 120 process requests from other nodes in addition to data access requests from the client terminals 101-104. This may cause a load imbalance among the nodes of the node cluster 150, especially if a particular data volume (e.g., data volume 112 of node 110) receives a large percentage of data access requests from another node (e.g., node 120). For example, the system resources (e.g., including both processor and aggregate resources) of the node storing the data volume may be much more heavily taxed than the system resources (e.g., processor overhead) of the other node. Thus, in some aspects, the server nodes of the node cluster 150 may selectively cache data volumes stored on other nodes in the node cluster 150 (e.g., in order to balance and/or reduce system load).

In some aspects, each of the nodes 110 and 120 includes a cache configurator 114 and 124, respectively, to detect and selectively cache “hot volumes.” A hot volume corresponds to a data volume that is the target of a large number of data access requests and, as a result, contributes heavily to the system load of its origin node (i.e., the node storing the hot volume). For example, the cache configurator 114 may monitor the data access requests 151 and/or 111 associated with the data volume 112 to determine whether data volume 112 is a hot volume. If the cache configurator 114 determines data volume 112 to be a hot volume, it may send a cache request 115 to the cache configurator 124 of node 120. Upon receiving the cache request 115, cache configurator 124 may selectively provision a data cache 122 to store a local copy 117 of the data volume 112.

In some aspects, the cache configurator 124 may monitor data access requests received by node 120, as well as system load parameters of the node 120, in order to determine whether to cache the data volume 112 on node 120. For example, it may not be desirable (or beneficial) to provision the cache 122 on node 120 unless a large number of data access requests for the data volume 112 are processed through node 120. Furthermore, it may not be feasible to provision the cache 122 if the system load of node 120 is too high (i.e., there is insufficient processor and/or aggregate headroom to handle the cache 122).

In some aspects, the cache configurator 124 may subsequently de-provision the cached volume 122 if it does not meet certain performance characteristics. For example, the cache configurator 124 may de-provision the cached volume 122 if it does not cause a marked improvement in the system load of node 110. The cache configurator 124 may also de-provision the cached volume 122 when it is no longer desirable (or beneficial) to maintain the cached volume 122, for example, based on the data access requests received by node 120 and/or upon receiving a cache request 115 associated with an even “hotter” volume.

By selectively provisioning (and de-provisioning) one or more caches to store copies of a data volume, the cache configurators 114 and 124 enable the overall system load of the node cluster 150 to be distributed across multiple nodes (e.g., nodes 110 and 120). In addition, the cache configurators 114 and 124 provide a mechanism for detecting hot volumes that contribute to load imbalances among the nodes 110 and 120, and identifying candidate nodes (e.g., node 120) for storing locally-cached copies of the hot volumes (e.g., cached volume 122) in order to alleviate such load imbalances.

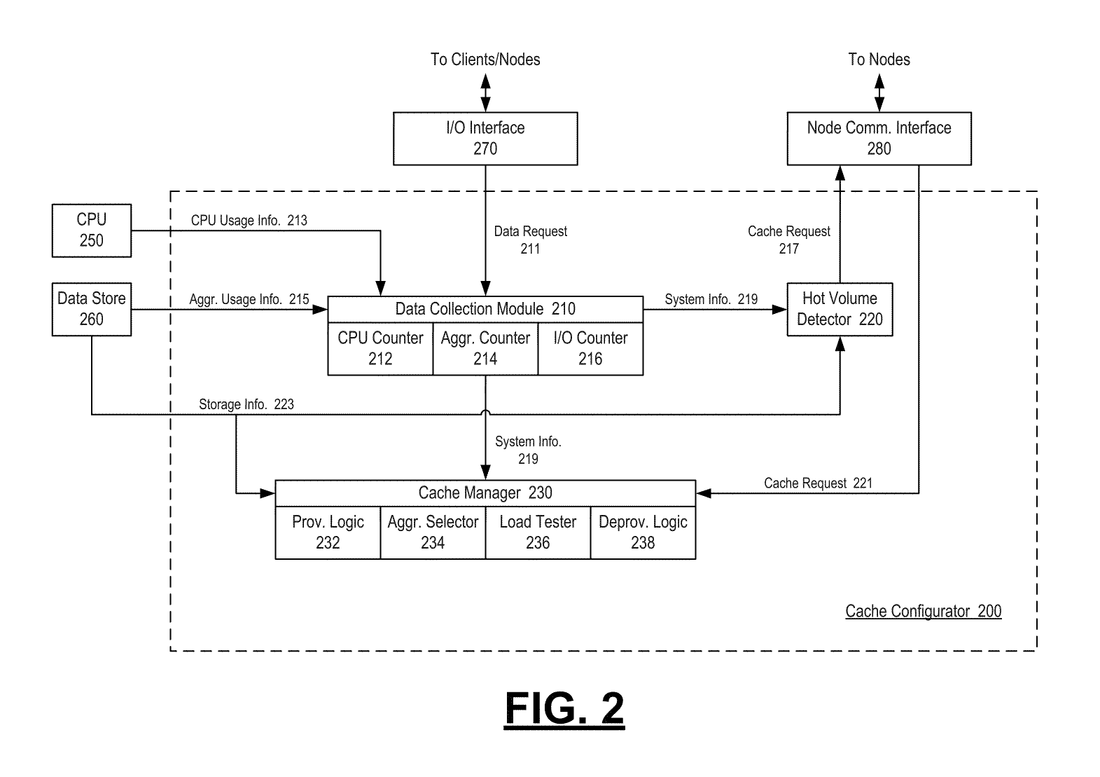

FIG. 2 illustrates a cache configurator 200 that is operable to provision and de-provision hot volume caches, in accordance with some aspects. The cache configurator 200 may be implemented on any server node of a node cluster. For example, with reference to FIG. 1, cache configurator 200 may correspond to the cache configurator 114 of node 110 and/or the cache configurator 124 of node 120. The cache configurator includes a data collection module 210, a hot volume detector 220, and a cache manager 230.

The data collection module 210 collects and/or organizes system data associated with the node in which the cache configurator 200 is implemented (i.e., the “current node”). In some aspects, the data collection module 210 may store information pertaining to system load as well as input/output (I/O) data characteristics. For example, the data collection module 210 may include a CPU counter 212 to receive CPU usage information 213 from the node's central processing unit (CPU) 250. The CPU counter 212 may periodically sample the CPU usage information 213 to store and/or update a record indicating an amount of available processor headroom. Specifically, the processor headroom indicates the bandwidth of the CPU 250 that is available for performing additional tasks (i.e., in addition to the tasks the CPU is currently performing).

The data collection module 210 may also include an aggregate counter 214 to receive aggregate usage information 215 from a data store 260 provided on the server node. For example, the aggregate counter 214 may periodically sample the aggregate usage information 215 to store and/or update a record indicating an amount an amount of available aggregate headroom. Specifically, the aggregate headroom indicates the bandwidth of an aggregate that is available for processing additional read and/or write operations with respect to a corresponding data volume in the data store 260. In some aspects, wherein the data store 260 includes multiple aggregates, the aggregate counter 214 may maintain a separate record for each aggregate in the data store 260. For example, the aggregate headroom for a particular aggregate may be stored in a separate partition of the aggregate counter 214 than the aggregate headroom for a different aggregate.

Further, the data collection module 210 may include an I/O counter 216 to receive data access requests 211 from other nodes and/or clients (e.g., received via an I/O interface 270). The I/O counter 216 may store and/or update a record associated with one or more I/O characteristics of the current node based on the received data access requests 211. For example, the I/O counter 216 may count the total number of data access requests received for a particular data volume (e.g., over a predetermined period of time). Further, the I/O counter 216 may also count the number of read (or write) operations to be performed on a particular data volume. In some aspects, the I/O counter 216 may maintain a separate record for each data volume. For example, the number of data access requests counted for a particular data volume may be stored in a separate partition of the I/O counter 216 than the number of data access requests counted for a different data volume.

The hot volume detector 220 detects hot volumes on the current node that may benefit from caching. For example, the hot volume detector 220 may receive system information 219 from the data collection module 210, and identify one or more hot volumes stored on the current node (i.e., in the data store 260) based on the system information 219. The system information 219 may include the CPU headroom data stored in the CPU counter 212, the aggregate headroom data stored in the aggregate counter 214, and the I/O data stored in the I/O counter 216. For example, the hot volume detector 220 may first analyze the available CPU headroom to determine whether the current node is overtaxed, and may therefore benefit from dynamic hot volume caching.

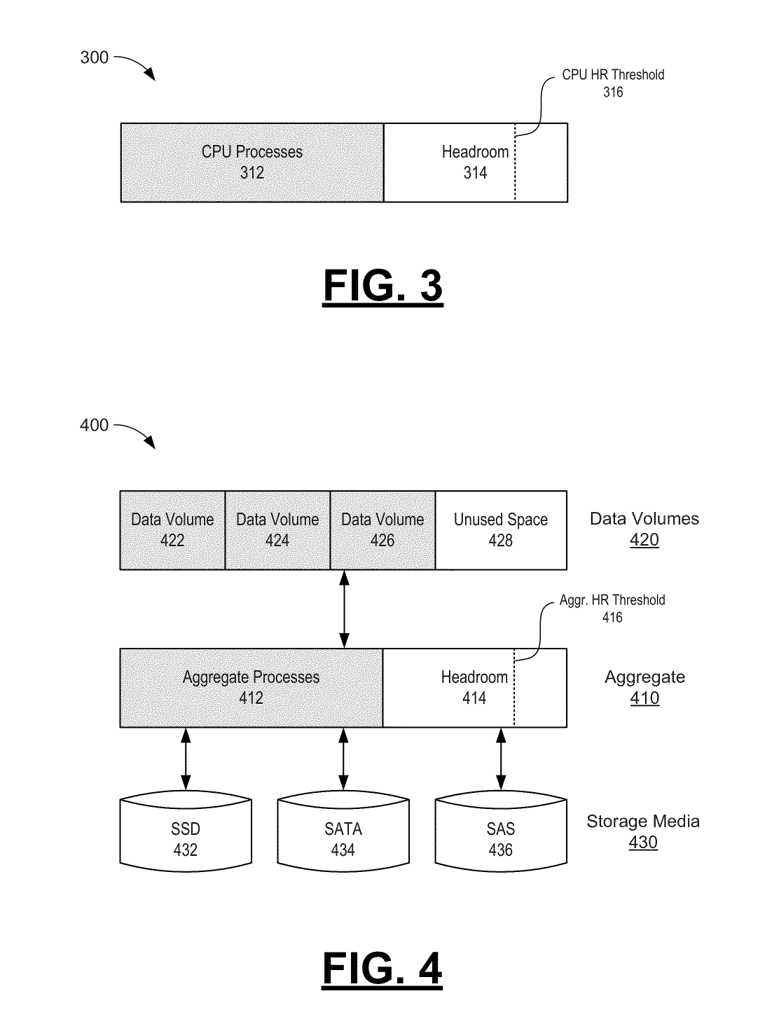

FIG. 3 illustrates an exemplary resource-usage model of a CPU 300 that may be implemented in one or more nodes of a data storage system according to present aspects. For example, the CPU 300 may correspond with CPU 250 of FIG. 2. As shown in FIG. 3, CPU utilization is depicted with respect to CPU processes 312 and available headroom 314. The CPU processes 312 correspond to the number of tasks the CPU 300 is handling (e.g., either concurrently or in a queue). At least some of the processes 312 correspond to read and/or write operations associated with a corresponding data store. The headroom 314 corresponds to the available CPU bandwidth for processing additional tasks (i.e., in addition to the current CPU processes 312). Typically, the CPU 300 is unable to process additional tasks if there is no available headroom 314.

The hot volume detector 220 may determine that the current node could potentially benefit from dynamic hot volume caching if the CPU 300 is out of headroom 314. In some aspects, the hot volume detector 220 may determine that the CPU 300 could benefit from dynamic hot volume caching if the amount of available headroom 314 is below a CPU headroom (HR) threshold 316. The CPU HR threshold 316 may correspond to, for example, a minimum amount of headroom 314 needed for the CPU 300 to function normally (or perform at a threshold level of efficiency). In other words, the performance of the CPU 300 may be very slow and/or inefficient if the available headroom 314 falls below the CPU HR threshold 316.

The hot volume detector 220 may further analyze the available aggregate headroom to determine whether there is in fact a hot volume (in the data store 260) to be cached. As described above, the data store 260 may include multiple aggregates, each associated with a number of data volumes. Thus, in some aspects, the hot volume detector 220 analyzes the headroom of each aggregate in the data store 260 in order to identify one or more aggregates that are overtaxed, and may thus benefit from dynamic hot volume caching.

FIG. 4 illustrates an exemplary resource-usage model of a data store 400 that may be implemented in one or more nodes of a data storage system according to present aspects. For example, the data store 400 may correspond with data store 260 of FIG. 2. The data store 400 includes an aggregate 410 coupled to a set of storage media 430, which comprises the physical medium on which data is stored. It should be noted that, while only one aggregate 410 is depicted, for purposes of simplicity, the data store 400 may include any number of aggregates.

The storage media 430 may include hard drives of various types of media. For example, the storage media 430 may include a solid state drive (SSD) 432, a SATA-based hard drive 434, and a SAS-based hard drive 436. The aggregate 410 maps a set of data volumes 420 to the physical storage media 430. For example, the set of data volumes 420 may comprise multiple data volumes 422-426, including unused space 428 which may be provisioned for additional data volumes and/or hot volume caches. Each data volume 422-426 represents a record (e.g., logical combination) of a set of data stored in one of the hard drives 432-436. Furthermore, each hard drive 432-436 may be associated with one or more data volumes 422-426.

When a user requests to read from or write to a particular data volume 422-428, the aggregate 410 identifies the hard drive 432-436 associated with that data volume and performs the corresponding operation on that drive. Thus, aggregate utilization is depicted with respect to aggregate processes 412 and available headroom 414. The aggregate processes 412 correspond to the number of tasks (e.g., read and/or write operations) the aggregate 410 is handling, and the headroom 414 corresponds to the available aggregate bandwidth for performing additional operations (i.e., in addition to the current aggregate processes 412). The aggregate 410 may be unable to process additional tasks if there is no available headroom 414.

The hot volume detector 220 may identify a hot volume by first analyzing the available headroom for the aggregate 410. For example, the aggregate 410 may be associated with a hot volume if it is out of headroom 414. In some aspects, the hot volume detector 220 may determine that the aggregate 410 is associated with a hot volume if the amount of available headroom 414 is below an aggregate HR threshold 416. The aggregate HR threshold 416 may correspond to, for example, a minimum amount of headroom 414 needed for the aggregate 410 to function normally (or perform at a threshold level of efficiency). Thus, the performance of the aggregate 410 may be very slow and/or inefficient if the available headroom 414 falls below the aggregate HR threshold. 416.

Upon identifying a low-bandwidth aggregate 410, the hot volume detector 220 may further analyze storage information 223 received from the data store 260 to determine which of the corresponding data volumes 422-426 are contributing to the aggregate load. The storage information 223 may include information pertaining to the data volumes stored by the data store 260. For example, the storage information 223 may include: an amount of used and/or unused storage space (i.e., for storing data volumes) on each aggregate; the size and/or location of each data volume; the types of storage media associated with each aggregate; and/or the number of read/write operations being performed on each data volume.

The hot volume detector 220 may identify hot volumes by analyzing the read/write operations being performed on each data volume. It should be noted that read/write operations performed on a data volume are translated into corresponding disk I/O operations that are executed by the data volume and performed on the storage media 430. In some aspects, any data volume that is performing disk I/O operations on the storage media 430 (while the aggregate 410 is in a low-bandwidth state) may be flagged or otherwise identified as a hot volume. In some aspects, only data volumes that perform a significant (i.e., threshold) number of disk I/O operations are identified as hot volumes. This operation may be repeated to identify any and all hot volumes associated with each aggregate in the data store 260.

Upon identifying one or more hot volumes, the hot volume detector 220 may output a cache request 217 to other nodes in the node cluster (e.g., via a node communications interface 280). For example, the cache request 217 may indicate the size and/or location of each hot volume identified in the data store 260. The cache request 217 may also specify the type of storage media (e.g., SSD, SATA, and/or SAS) associated with a particular hot volume. In some aspects, the cache request 217 may further indicate the total number of data access requests 211 received (and/or processed) for each hot volume.

The cache manager 230 analyzes cache requests 221 received from other nodes, via the node communications interface 280, and selectively provisions a cache to store a copy of a corresponding hot volume. For example, the cache manager 230 may include a provisioning logic 232 to determine whether to cache the hot volume on the current node. The provisioning logic 232 may determine whether to cache a hot volume based, in part, on system information 219 received from the data collection module 210. As described above, the system information 219 may include the CPU headroom data stored in the CPU counter 212, the aggregate headroom data stored in the aggregate counter 214, and the I/O data stored in the I/O counter 216.

In some aspects, the provisioning logic 232 may compare the total number of data access requests associated with a particular hot volume (e.g., as provided with the cache request 221) with the number of locally-received data access requests for that volume (e.g., based on the I/O data provided with the system information 219) to determine whether the volume should be cached on the current node. For example, it may be undesirable to cache an external volume if all of the data access requests for that volume are routed through the current node (i.e., it may be preferable to completely move the volume onto the current node).

Further, in some aspects, the provisioning logic 232 may analyze the I/O data associated with the current node to determine whether caching the hot volume on the current node would improve and/or balance the overall system load of the node cluster. For example, it may be desirable to cache a hot volume if the current node receives a significant (e.g., threshold) number of data access requests for that particular volume. It may also be desirable to cache a hot volume if a substantial percentage (e.g., 95%) of the data access requests for that volume correspond to read operations. When a write operation is performed on a local cached volume, a similar write operation is typically also performed on the original data volume (i.e., to maintain synchronization among copies of the data volume). Thus, performing write operations on a cached volume may not reduce inter-node traffic, but rather, actually increases the overall system load of the node cluster. In contrast, read operations may be performed on a local cached volume without requiring any additional operations to be performed on the original data volume (i.e., since no data is altered).

The cache manager 230 may include an aggregate selector 234 to determine which, if any, of the aggregates in the data store 260 is to host a cached volume. In some aspects, the aggregate selector 234 may analyze the CPU and aggregate headroom data provided with the system information 219 to determine whether the system resources of the current node have sufficient bandwidth to accommodate (processing read/write operations for) a cached volume. For example, the CPU and aggregate headroom data may be compared against predetermined CPU and aggregate HR thresholds, respectively, which correspond with a minimum amount of bandwidth required for the CPU and a corresponding aggregate to maintain a threshold (e.g., normal) level of performance. In some aspects, the aggregate selector 234 may analyze the amount of aggregate headroom available for each aggregate provided in the data store 260. If either the CPU and/or aggregate headroom is below a corresponding threshold, the aggregate selector 234 may indicate that no host aggregate is available to host the cached volume.

Further, in some aspects, the aggregate selector 234 may analyze storage information 223 from the data store 260 to select an aggregate to host the cache. As described above, the storage information 223 may include: an amount of used and/or unused storage space on each aggregate for storing data volumes; the size and/or location of each data volume; the types of storage media associated with each aggregate; and/or the number of read/write operations being performed on each data volume. For example, the aggregate selector 234 may select a host aggregate that has sufficient unused space (e.g., at least 115% of the working-set-size) to store a copy of the hot volume (e.g., based on the storage size provided with the cache request 221). Alternatively, or in addition, the aggregate selector 234 may select a host aggregate having storage media that performs as well (if not better) than the storage medium on which the hot volume is originally stored (e.g., based on the media type provided with the cache request 221).

Once an aggregate is selected, the cache manager 230 may instruct the current node to store a local copy of the hot volume on the selected aggregate. The current node may store the copy of the volume using any combination of caching operations that are well-known in the art. For example, the current node may transmit one or more data access requests to the node on which the original hot volume is stored (i.e., the “origin” node) to read/retrieve each item of data in the hot volume.

The cache manager 230 may include a load tester 236 to determine whether or not to keep the recently-cached hot volume. For example, it may be undesirable to maintain the cached volume if the system load of the origin volume does not improve (e.g., by at least a threshold amount) as a result of the caching. It may also be undesirable to maintain the cached volume if it significantly increases the system load of the current node (e.g., potentially outweighing any improvement to the system load of the origin node).

The load tester 236 may determine whether to de-provision the cached volume based on the system information 219 and the cache request 221. In some aspects, the load tester 236 may de-provision the cached volume if the available CPU and/or aggregate headroom of the current node (e.g., indicated by the system information 219) is reduced by at least a threshold amount as a result of the caching. In some aspects, the load tester 236 may de-provision the cached volume upon detecting a subsequent cache request 221 for the same hot volume (e.g., thus indicating that the system load of the origin node did not improve as a result of the caching).

The cache manager 230 may also include a de-provisioning logic 238 to determine whether to de-provision any cached volumes stored in the data store 260 based on changes to the system load and/or I/O traffic of the current node (e.g., the cached volume may be a “bad cache”). For example, it may be undesirable to maintain a particular cached volume if all data access requests associated with the original hot volume are routed through the current node (i.e., it may be preferable to completely offload the hot volume from the origin node onto the current node). It may also be undesirable to maintain a particular cached volume if the percentage of data access requests for that volume corresponding to read operations drops below a threshold percentage (e.g., 80%). Further, the cache manager 230 may de-provision a cached volume if the aggregate on which the volume is stored runs out of storage space (i.e., the amount of unused space for the aggregate does not meet a threshold amount).

In some aspects, cache manager 230 may maintain a record of any recently de-provisioned caches (i.e., corresponding to hot volumes). More specifically, the cache manager 230 may store a record of a de-provisioned cache only if it was de-provisioned as a bad cache. The records may then be updated periodically, such that any record that is stored longer than a threshold duration is automatically deleted. In some aspects, the cache manager 230 may determine that a hot volume should not be cached if a cached volume corresponding to the same hot volume was recently de-provisioned (e.g., as a bad cache). For example, if a cached volume was recently de-provisioned (i.e., within the threshold duration), it is likely that the conditions affecting the decision to de-provision the cache have not changed. Thus, the cache manager 230 may refrain from caching a hot volume that was recently de-provisioned (e.g., as indicated by the record of the de-provisioned cache) in order to prevent constant provisioning and de-provisioning of caches for the same hot volume (i.e., to prevent “oscillations” in caching).

Further, in some aspects, the de-provisioning logic 238 may determine that one or more cached volumes should be de-provisioned in order to free up system resources on the current node to cache a new (i.e., hotter) hot volume. For example, if the current node does not have sufficient headroom and/or space to cache a new hot volume, the de-provisioning logic 238 may analyze any subsequent cache requests 221 to determine whether a corresponding hot volume is receiving substantially (e.g., 25%) more operations than one or more cached volumes currently stored in the data store 260 (e.g., as indicated by the I/O data stored in the I/O counter 216). The de-provisioning logic 238 may then de-provision a cached volume in order to cache a hotter volume, as long as doing so would not result in oscillations. In other words, the de-provisioning logic 238 may de-provision a cached volume in favor of a hotter volume if: (i) the hotter volume was not recently de-provisioned, and (ii) the cached volume was not recently provisioned.

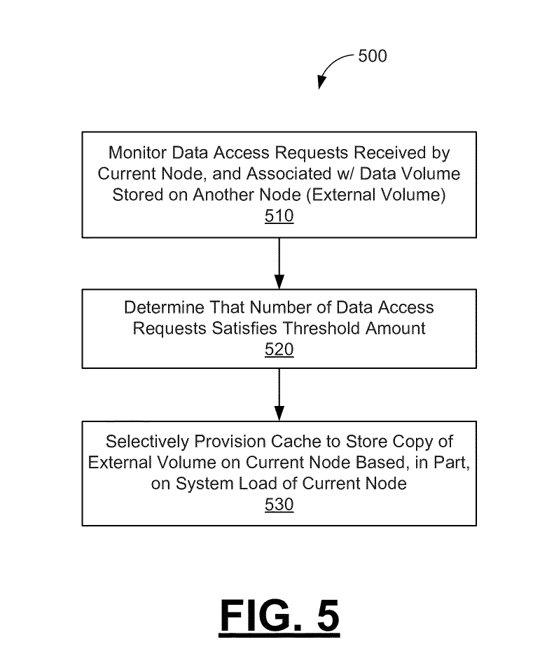

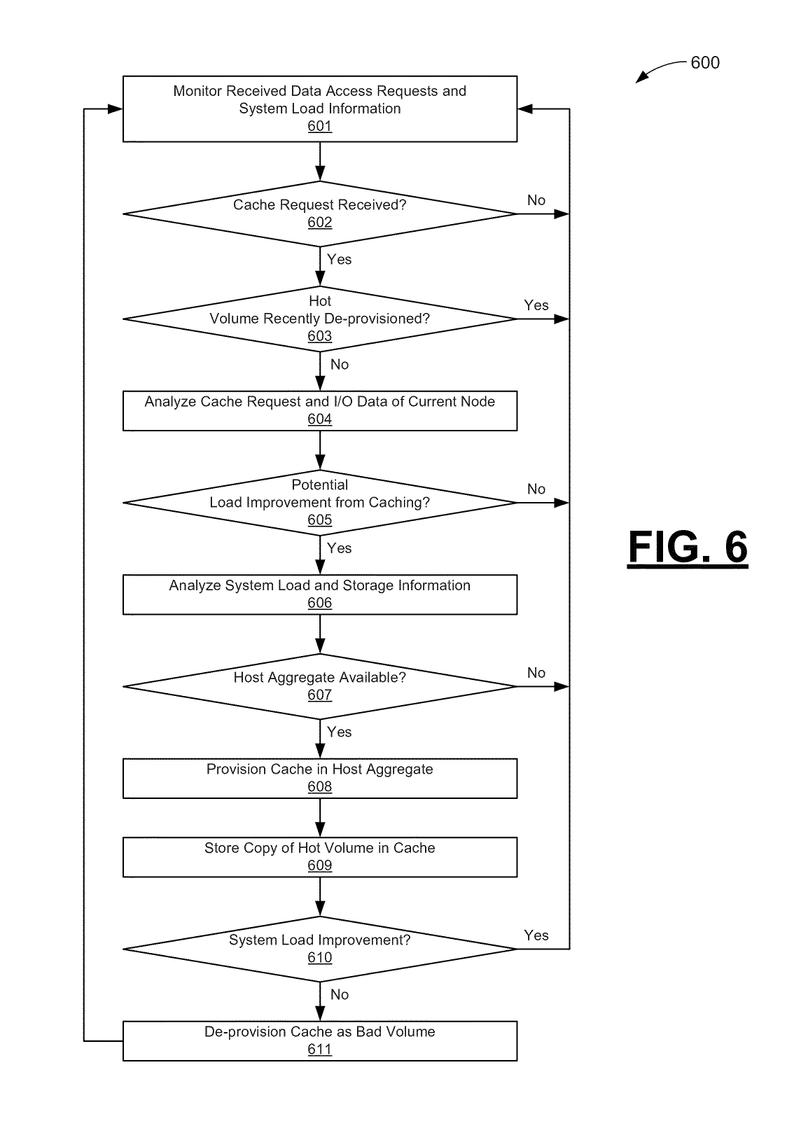

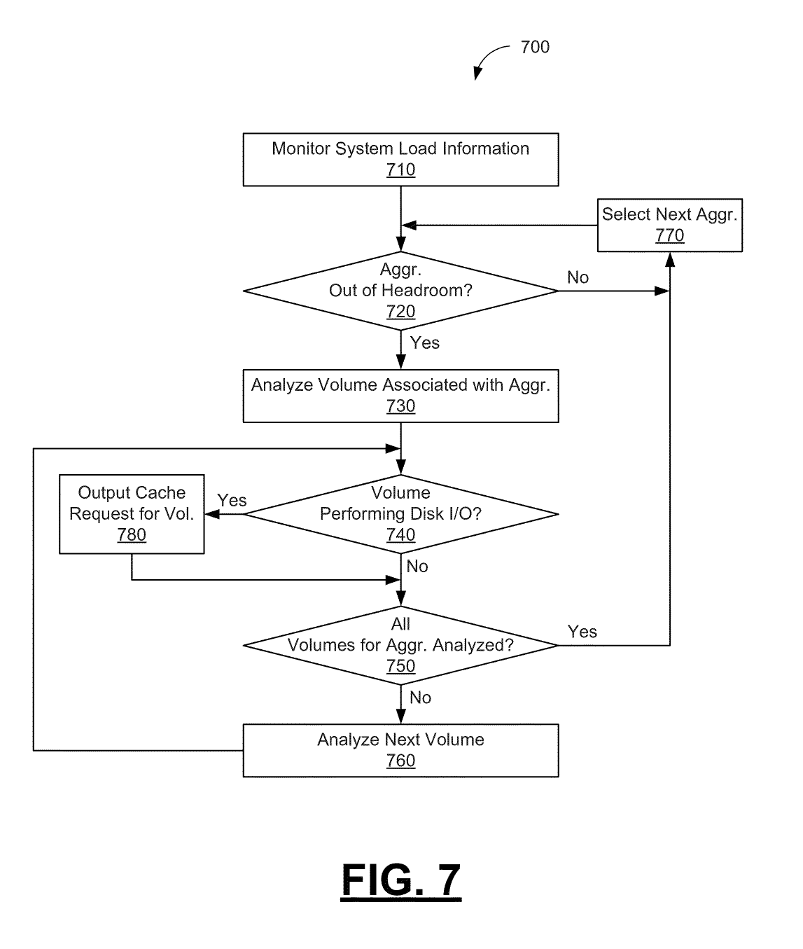

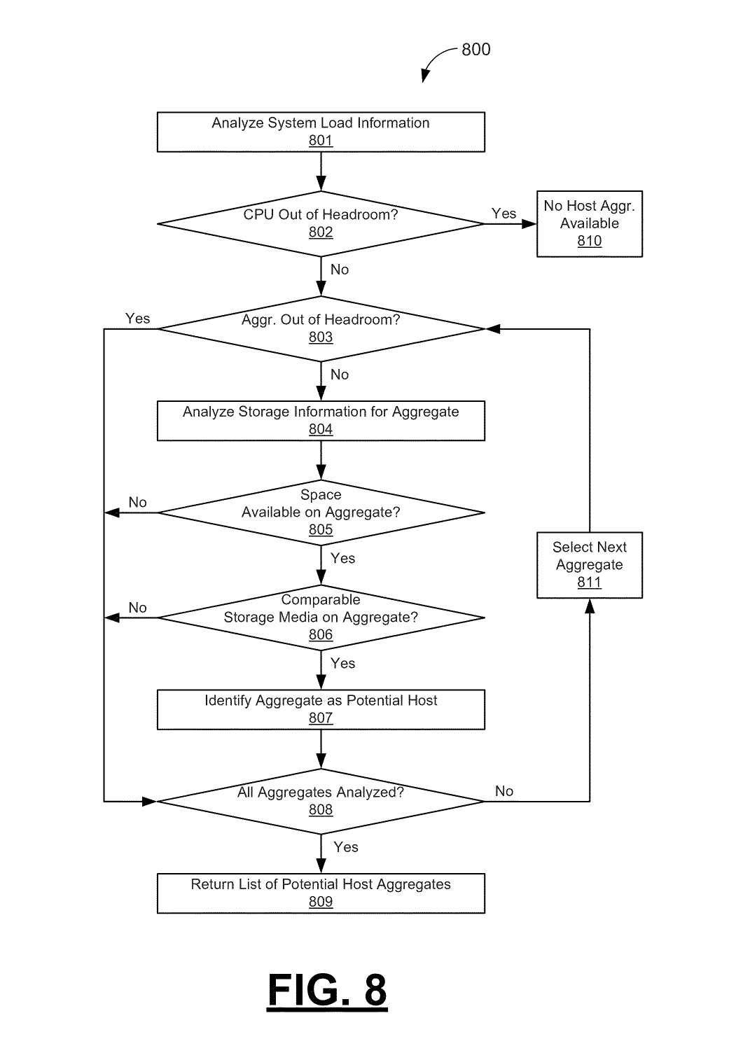

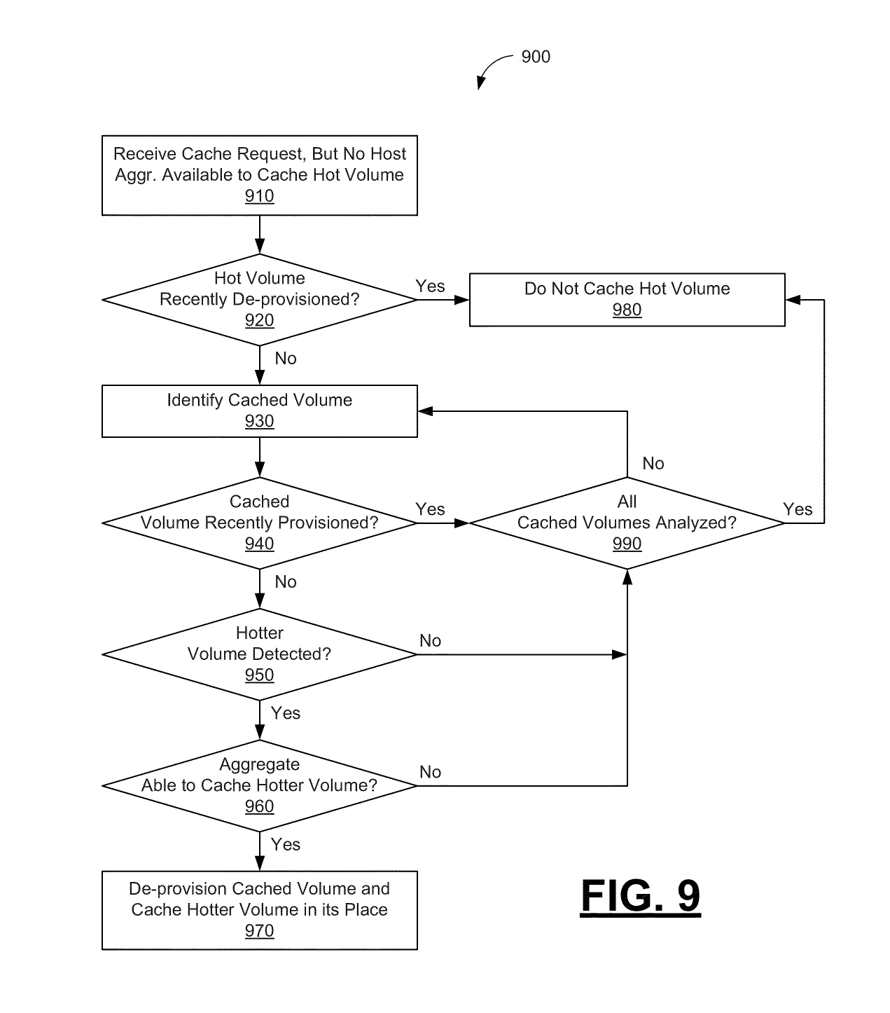

FIGS. 5 and 6 illustrate methods for dynamically caching hot volumes, in accordance with some aspects. FIG. 7 illustrates a method for detecting hot volumes on a current node, in accordance with some aspects. FIG. 8 illustrates a method for selecting an aggregate to host a cached volume, in accordance with some aspects. FIG. 9 illustrates a method for de-provisioning a cached volume in order to cache a hotter volume, in accordance with some aspects. Examples such as described with FIG. 5 through FIG. 10 can be implemented using, for example, a system such as described with FIGS. 1 and 2. Accordingly, reference may be made to elements of FIG. 1 and/or FIG. 2 for purpose of illustrating suitable elements or components for performing a step or sub-step being described.

FIG. 5 illustrates a method 500 for dynamically caching hot volumes, in accordance with some aspects. The method 500 may be implemented, for example, by cache configurator 124 as described above with respect to FIG. 1. The cache configurator 124 monitors data access requests received by the current node (i.e., node 120), and associated with a data volume stored on another node in the node cluster (510). For example, the data access requests may include requests 151 from client terminals 101-104 and/or requests from other nodes within the node cluster 150. As described above, each of the data access requests corresponds to a read or a write operation to be performed on a particular data volume stored (on one or more nodes) in the node cluster 150. In some aspects, the cache configurator 124 monitors those data access requests that correspond with operations to be performed on an external data volume (e.g., data volume 112 of node 110).

The cache configurator 124 then determines that a number of the received data access requests satisfies a threshold amount (520). For example, the cache configurator 124 may periodically compare the number of data access requests, received during a given interval, with one or more threshold amounts. As described above, it may be desirable to store a local copy of an external data volume (e.g., data volume 112) if a substantial number of data access requests for the external volume are routed through the current node (e.g., node 120) and/or a significant percentage of the received data access requests correspond to read operations. Thus, in some aspects, the threshold amount may correspond to a minimum number of data access requests being received over a given period. Further, in some aspects, the threshold amount may correspond to a minimum percentage (e.g., 95%) of the data access requests, received over a given period, being read operations.

Finally, the cache configurator 124 may selectively provision a cache to store a local copy of the external volume on the current node based, in part, on the system load of the current node (530). For example, it may not be feasible to cache an external data volume if the system load of the current node (e.g., node 120) is too high. In some aspects, the cache configurator 124 may monitor the available CPU and/or aggregate headroom of the current node to determine whether the system resources of the current node have sufficient bandwidth to accommodate (processing read/write operations for) a cached volume. For example, the cache configurator 124 may compare the available CPU and aggregate headroom with respective CPU and aggregate HR thresholds.

Further, in some aspects, the cache configurator 124 may monitor the available storage space and/or types of media associated with each aggregate of the current node to determine which, if any, of the aggregates is to host the cached volume. For example, the cache configurator 124 may select a host aggregate that has sufficient unused space (e.g., at least 115% of the working-set-size) to store a copy of the external volume. Alternatively, or in addition, the cache configurator 124 may select a host aggregate having storage media that performs as well (if not better) than the storage medium on which the external volume is originally stored.

FIG. 6 illustrates a more detailed aspect of a method 600 for dynamically caching hot volumes. The method 600 may be implemented, for example, by cache configurator 200 as described above with respect to FIG. 2. The cache configurator 200 monitors data access requests received by the current node and system load information of the current node (601). For example, the data collection module 210 may collect and store information pertaining to system load and I/O data characteristics. Specifically, the CPU counter 212 may periodically sample CPU usage information 213 from the CPU 250 to store and/or update a record indicating an amount of available processor headroom. The aggregate counter 214 may periodically sample aggregate usage information 215 from the data store 260 to store and/or update a record indicating an amount of available aggregate headroom. The I/O counter 216 may store and/or update a record associated with one or more I/O characteristics of the current node based on data access requests 211 received from client terminals and/or other nodes of a corresponding node cluster. As described above, the I/O characteristics may include the total number of data access requests received for a particular data volume over a given period of time and/or the number (or percentage) of those data access requests that correspond to read operations.

The cache configurator 200 may detect cache requests from other nodes in the node cluster (602). A cache request identifies one or more hot volumes stored on another node that may benefit from dynamic caching. For example, the cache request may indicate the size and/or location of each hot volume identified in the data store of a corresponding node. The cache request may also specify the type of storage media (e.g., SSD, SATA, and/or SAS) associated with a particular hot volume. In some aspects, the cache request may further indicate the total number of data access requests received and/or processed for each hot volume. As long as no cache request is received (602), the cache configurator 200 simply continues to monitor the received data access requests and system load information (601).

Upon receiving a cache request, the cache configurator 200 may first determine whether a corresponding hot volume was recently de-provisioned (603). For example, it may be undesirable to cache a hot volume that was de-provisioned within a threshold duration prior to receiving the current cache request (e.g., to avoid oscillations). Thus, if the cache configurator 200 determines that the hot volume was recently de-provisioned (603), it may simply continue to monitor the received data access requests and system load information (601).

As long as the hot volume was not recently de-provisioned (603), the cache configurator 200 may proceed to analyze the received cache request and I/O data of the current node to determine whether the hot volume should be cached on the current node (604). For example, the provisioning logic 232 may compare the total number of data access requests for a particular hot volume (e.g., as provided with the cache request 221) with the number of locally-received data access requests for that volume (e.g., based on the I/O data provided with the system information 219) to determine if all of the data access requests for the hot volume are routed through the current node. The provisioning logic 232 may further analyze the I/O data for the current node to determine whether the current node receives a threshold amount of data access requests, such that caching the hot volume on the current node is likely to improve the system load of the origin node. For example, the threshold amount may correspond to a minimum number of data access requests for the particular hot volume and/or a minimum percentage (e.g., 95%) of the data access requests being read operations.

The cache configurator 200 then determines, based on the system information 219 and/or the received cache request 221, whether dynamic caching is likely to improve (or balance) the overall system load of the node cluster (605). For example, dynamically caching a hot volume may not improve the overall system load of the node cluster if all data access requests for the hot volume are routed through the current node and/or the current node does not receive at least a threshold amount (e.g., number and/or percentage) of data access requests. If dynamic caching would not improve the overall system load of the node cluster (605), the cache configurator 200 simply continues to monitor the received data access requests and system load information (601).

Upon determining that dynamic caching is likely to improve the overall system load (605), the cache configurator 200 may proceed to analyze the system load and storage information of the current node to determine whether the current node is capable of caching the hot volume (606). For example, the aggregate selector 234 may analyze the storage information 223 to determine which, if any, of the aggregates in the data store 260 has sufficient unused space (e.g., at least 115% of the working-set-size) to store a copy of the hot volume. The aggregate selector 234 may also compare the types of storage media associated with each of the aggregates to determine which, if any, of the aggregates includes storage media that performs as well as (if not better than) the storage medium on which the hot volume is originally stored. Further, the aggregate selector 234 may compare CPU and aggregate headroom data (e.g., provided with the system information 219) against CPU and aggregate HR thresholds, respectively, to determine whether the system resources of the current node have sufficient bandwidth to accommodate (processing read/write operations for) the hot volume.

The cache configurator 200 then determines, based on the system information 219 and/or the storage information 223, whether an aggregate is available on which to cache the hot volume (607). For example, the current node may be unable to cache the hot volume if no aggregate is available with adequate storage resources (e.g., unused storage space is below threshold level and/or available media types are inferior to original storage medium) or sufficient bandwidth (e.g., CPU and/or aggregate headroom are below threshold levels). If no host aggregate is available (607), the cache configurator 200 simply continues to monitor the received data access requests and system load information (601). However, upon identifying or selecting an aggregate to host a cached volume (607), the cache configurator 200 may proceed by provisioning a corresponding cache on the host aggregate (608) and storing a local copy of the hot volume in the cache (609).

The cache configurator 200 may then determine whether the overall system load of the node cluster improves as a result of caching the hot volume (610). For example, the load tester 236 may determine that the load of the origin volume did not improve as a result of the caching if it detects a subsequent cache request 221 for the recently-cached volume. The load tester 236 may further determine that the burden to the current node, as a resulting of the caching, outweighs any potential benefit to the origin node if the CPU and/or aggregate headroom of the current node is reduced by at least a threshold amount.

If the overall system load of the node cluster improves as a result of caching the hot volume (610), the cached volume is maintained on the current node and the cache configurator 200 continues to monitor the received data access requests and system load information (601). However, if the overall system load of the node cluster does not improve (610), the cache configurator 200 may then de-provision the corresponding cache (611) and continue to monitor the received data access requests and system load information (601). For example, the load tester 236 may de-provision a recently-cached volume upon detecting a subsequent cache request 221 for the same hot volume and/or determining that the CPU and/or aggregate headroom of the current node is reduced by at least a threshold amount as a result of the caching.

FIG. 7 illustrates a method 700 for detecting hot volumes on a current node, in accordance with some aspects. The method 700 may be implemented, for example, by the cache configurator 200 and, more specifically, the hot volume detector 220 of FIG. 2. The hot volume detector 220 monitors system load information of the current node (710). For example, the hot volume detector 220 may receive and/or retrieve the system information 219 from the data collection module 210. As described above, the system information 219 may include aggregate headroom data for each aggregate in the data store 260.

The hot volume detector 220 first selects an aggregate on the current node (e.g., in the data store 260) and determines whether the selected aggregate is out of headroom (720). For example, the hot volume detector 220 may compare the aggregate headroom for the selected aggregate with an aggregate HR threshold, which corresponds to a minimum amount of headroom needed for the aggregate to perform at a threshold level of efficiency. The hot volume detector 220 may determine that the selected aggregate is out of headroom if the amount of available aggregate headroom is equal to or less than the aggregate HR threshold. If the selected aggregate is not out of headroom (720), the hot volume detector 220 may then select another aggregate to analyze (770).

Once the hot volume detector 220 determines that a selected aggregate is out of headroom (720), it may then select and analyze a data volume associated with that aggregate (730). For example, the hot volume detector 220 may analyze storage information 223 from the data store 260 to detect one or more hot volumes associated with the selected aggregate. As described above, the storage information 223 may include the number of read and/or write operations being performed on each data volume in the data store 260. It is further noted that read/write operations performed on a data volume are translated into disk I/O operations on a corresponding storage medium. Thus, the hot volume detector 220 may examine the number of read/write operations being performed on the selected volume to determine whether that volume is contributing to the out-of-headroom determination for the corresponding aggregate (740).

If the selected volume is performing disk I/O (740), the hot volume detector 220 may output a cache request identifying the selected volume as a hot volume (780). For example, the cache request may indicate the size and/or location of the selected volume. The cache request may also specify the type of storage media associated with that volume. Still further, the hot volume detector 220 may include the number of data access requests received and/or processed for the selected volume. In some aspects, the hot volume detector 220 may output the cache request only if the selected volume is performing a substantial (i.e., threshold) number of disk I/O operations.

As long as all of the data volumes for the selected aggregate have not been analyzed (750), the hot volume detector 220 may proceed to select and analyze another volume associated with the current aggregate (760). Once all volumes for the current aggregate have been analyzed (750), the hot volume detector 220 may then select another aggregate to be analyzed (770). In some aspects, the hot volume detector 220 continuously or periodically monitors the system load information (710), even while performing other tasks (e.g., 720-780).

FIG. 8 illustrates a method 800 for selecting an aggregate to host a cached volume, in accordance with some aspects. The method 800 may be implemented, for example, by the cache configurator 200 and, more specifically, the aggregate selector 234 of FIG. 2. The aggregate selector 234 analyzes system load information of the current node (801). For example, the aggregate selector 234 may receive and/or retrieve the system information 219 from the data collection module 210. As described above, the system information 219 may include CPU and aggregate headroom data.

The aggregate selector 234 determines, based on the CPU headroom data, whether the CPU of the current node (e.g., CPU 250) is out of headroom (802). For example, the aggregate selector 234 may compare the available CPU headroom with a CPU HR threshold, which corresponds to a minimum amount of CPU headroom needed for the CPU to perform at a threshold level of efficiency. The aggregate selector 234 may determine that the CPU is out of headroom if the amount of available CPU headroom is equal to or less than the CPU HR threshold. If the CPU is out of headroom (802), the aggregate selector 234 may indicate that no host aggregate is available to cache a hot volume stored on another node (810).

If the aggregate selector 234 determines that the CPU is not out of headroom (802), it may then select an aggregate on the current node (e.g., in the data store 260) and determine whether the selected aggregate is out of headroom (803). For example, the aggregate selector 234 may compare the available aggregate headroom for the selected aggregate with an aggregate HR threshold, which corresponds to a minimum amount of headroom needed for the aggregate to perform at a threshold level of efficiency. The aggregate selector 234 may determine that the selected aggregate is out of headroom if the amount of available aggregate headroom is equal to or less than the aggregate HR threshold. If the selected aggregate is out of headroom (803), and not all aggregates on the current node have been analyzed (808), the aggregate selector 234 may then select another aggregate to analyze (811).

Once the aggregate selector 234 identifies an aggregate that is not out of headroom (803), it may then proceed to analyze the storage information associated with the selected aggregate (804). For example, the aggregate selector 234 may receive and/or retrieve storage information 223 from the data store 260, which includes an amount of used and/or unused storage space on each aggregate and the types of storage media associated with each aggregate. More specifically, the aggregate selector 234 may analyze the storage information 223 to determine whether or not the selected aggregate is capable of hosting a cache to store a copy of a hot volume on another node.

The aggregate selector 234 determines, based on the storage information, whether sufficient space is available on the selected aggregate to provision a cache (805). In some aspects, the aggregate selector 234 may compare the amount of unused space of current aggregate with the size of the hot volume to be cached (e.g., as indicated in a corresponding cache request). For example, the aggregate selector 234 may determine that the selected aggregate has sufficient unused space if at least 115% of the working-set-size of the hot volume is available for storage. If the selected aggregate does not have sufficient storage space (805), and not all aggregates on the current node have been analyzed (808), the aggregate selector 234 may subsequently select another aggregate to analyze (811).

If the selected aggregate has sufficient storage space to host a cache (805), the aggregate selector 234 may then determine whether the storage media associated with the selected aggregate is at least comparable (or superior) in performance to the storage medium on which the hot volume is originally stored (806). In some aspects, the aggregate selector 234 may compare the types of storage media available on the current aggregate with type of storage medium on which the hot volume is stored (e.g., as indicated in a corresponding cache request). For example, flash or non-volatile memory (e.g., SSD) may be deemed superior to volatile memory (e.g., HDD), and SAS-based hard drive interfaces may be deemed superior to SATA-based interfaces. However, a flash pool (e.g., SSD+SATA or SSD+SAS) may be deemed superior to any volatile memory equipped with either SATA or SAS. If the selected aggregate does not have at least comparable storage media (806), and not all aggregates on the current node have been analyzed (808), the aggregate selector 234 may then select another aggregate to analyze (811).

If the selected aggregate has comparable or better storage media (806), the aggregate selector 234 may then flag or otherwise identify the selected aggregate as a potential host aggregate (807). Then, if not all aggregates on the current node have been analyzed (808), the aggregate selector 234 may select another aggregate to analyze (811). This process (803-808 and 811) may be repeated until all of the aggregates on the current node have been analyzed. However, in some aspects, the aggregate selector 234 may terminate the aggregate selection process 800 as soon as an aggregate has been identified as a potential host (807).

After all aggregates on the current node have been analyzed (808), the aggregate selector 234 may return a list of potential host aggregates (809). For example, the aggregate selector 234 may provide the list to the cache manager 230 and/or the provisioning logic 232 to enable a hot volume cache to be provisioned on the selected aggregate in the data store 260. In some aspects, the potential host aggregates in the list may be ranked based on their associated load and/or storage properties (e.g., aggregate overhead, available storage space, media types, etc.). In some aspects, the aggregate selector 234 may simply select the highest-ranked host aggregate in the list to be provided to the cache manager 230 and/or provisioning logic 232.

FIG. 9 illustrates a method 900 for de-provisioning a cached volume in order to cache a hotter volume, in accordance with some aspects. The method 900 may be implemented, for example, by the cache configurator 200 and, more specifically, the cache manager 230 of FIG. 2. The cache manager 230 receives a cache request for a hot volume, but may determine that no host aggregate is available on which to provision a cache for the hot volume (910). For example, the cache manager 230 may determine, based on the system information 219 and storage information 223, that the current node does not have sufficient processing and/or storage resources (e.g., CPU headroom, aggregate headroom, unused space, and/or supported media types) to cache the hot volume.

The cache manager 230 may then determine whether the hot volume identified in the cache request was recently de-provisioned (920). For example, the cache manager 230 may maintain a record of any recently de-provisioned caches (e.g., corresponding to bad caches). Further, the records may be updated periodically by deleting any record that has been stored for longer than a threshold duration (e.g., corresponding to a minimum oscillation period). This ensures that only records of “recently” de-provisioned caches are kept. If the hot volume in the cache request was recently de-provisioned (920), the cache manager 230 may refrain from attempting to cache the current hot volume (980). For example, it may be desirable to prevent oscillations in caching.

If the cache manager 230 determines that the hot volume was not recently de-provisioned (920), it may proceed to identify a cached volume on the current node (930). A cached volume may correspond to any cache in the data store 260 that stores a copy of a hot volume originally stored on another node. It should be noted that the operation 900 may be invoked only if there is at least one cached volume on the current node. Alternatively, the operation 900 may simply terminate if the cache manager 230 is unable to identify a cached volume on the current node.

The cache manger 230 then determines whether the cached volume was recently provisioned or stored on the current node (940). In some aspects, the cache manager 230 may maintain a record of each recently provisioned cache. For example, the cache manager 230 may periodically update the records by deleting any record that has been stored for longer than a threshold duration (e.g., corresponding to a minimum oscillation period). This ensures that only records of “recently” provisioned caches are kept. If the cached volume was only recently provisioned (940), and not all cached volumes on the current node have been analyzed (990), the cache manager 230 may proceed to identify another cached volume (930). However, once all cached volumes on the current node have been analyzed (990), the cache manager 230 simply refrains from caching the new hot volume (980).

If the cache manager 230 determines that the cached volume was not recently provisioned (940), it may then determine whether the new hot volume is even “hotter” than the cached volume (950). For example, the cache manager 230 may analyze the I/O data provided with the system information 219, to compare the number of data requests for the new hot volume with the number of data requests for the cached volume. More specifically, the new hot volume may be a hotter volume if it receives substantially (e.g., 25%) more data access requests than the cached volume. If the new hot volume is not hotter than the cached volume (950), and not all cached volumes on the current node have been analyzed (990), the cache manager 230 may proceed to identify another cached volume (930).

If a hotter volume is detected (950), the cache manager 230 may then determine whether the aggregate currently hosting the cached volume would be able to cache the hotter volume in absence of the cached volume (960). For example, the cache manager 230 may predict the availability of processing and/or storage resources on the current aggregate (e.g., aggregate headroom, unused space, and supported media type) if the cached volume were de-provisioned. Further, the cache manager 230 may determine whether, given the predicted availability of resources, the current aggregate would be able to host a cache to store a local copy of the hotter volume (e.g., as described above with respect to FIG. 8).

If the current aggregate would not be able to cache the hotter volume even if the cached volume were de-provisioned (960), and not all cached volumes on the current node have been analyzed (990), the cache manager 230 may proceed to identify another cached volume (930). However, if the cache manager 230 determines that the current aggregate is able to cache the hotter volume in absence of the cached volume (960), it may proceed to de-provision the cached volume on current aggregate and, in its place, provision a new cache to store the hotter volume.

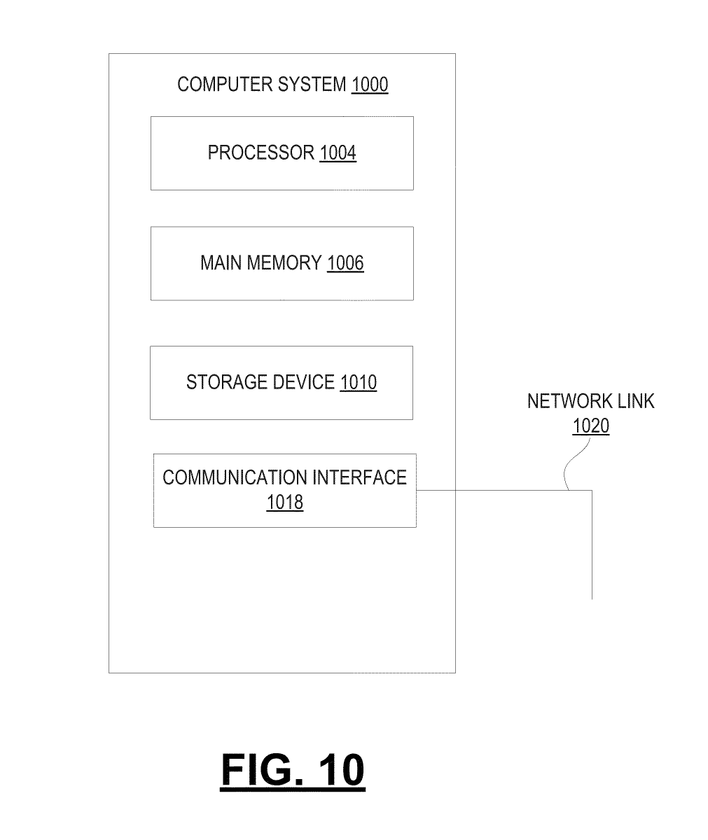

FIG. 10 is a block diagram that illustrates a computer system upon which aspects described herein may be implemented. For example, in the context of FIGS. 1 and 2, the cache configurators 124 and 200, respectively, may be implemented using one or more computer systems such as described by FIG. 10. In the context of FIG. 1, the server nodes 110-120 may also be implemented using one or more computer systems such as described with FIG. 10. Still further, methods such as described with FIGS. 5-9 can be implemented using a computer such as described with an example of FIG. 10.

In an aspect, computer system 1000 includes processor 1004, memory 1006 (including non-transitory memory), storage device 1010, and communication interface 1018. Computer system 1000 includes at least one processor 1004 for processing information. Computer system 1000 also includes a main memory 1006, such as a random access memory (RAM) or other dynamic storage device, for storing information and instructions to be executed by processor 1004. Main memory 1006 also may be used for storing temporary variables or other intermediate information during execution of instructions to be executed by processor 1004. Computer system 1000 may also include a read only memory (ROM) or other static storage device for storing static information and instructions for processor 1004. A storage device 1010, such as a magnetic disk or optical disk, is provided for storing information and instructions. The communication interface 1018 may enable the computer system 1000 to communicate with one or more networks through use of the network link 1020 (wireless or wireline).

In one implementation, memory 1006 may store instructions for implementing functionality such as described with an example of FIGS. 1 and 2, or implemented through an example method such as described with FIGS. 5-9. Likewise, the processor 1004 may execute the instructions in providing functionality as described with FIGS. 1 and 2 or performing operations as described with an example method of FIGS. 5-9.

Examples described herein are related to the use of computer system 1000 for implementing the techniques described herein. According to one aspect, those techniques are performed by computer system 1000 in response to processor 1004 executing one or more sequences of one or more instructions contained in main memory 1006. Such instructions may be read into main memory 1006 from another machine-readable medium, such as storage device 1010. Execution of the sequences of instructions contained in main memory 1006 causes processor 1004 to perform the process steps described herein. In alternative aspects, hard-wired circuitry may be used in place of or in combination with software instructions to implement aspects described herein. Thus, aspects described are not limited to any specific combination of hardware circuitry and software.

Although illustrative examples have been described in detail herein with reference to the accompanying drawings, variations to specific aspects and details are encompassed by this disclosure. It is intended that the scope of aspects described herein be defined by claims and their equivalents. Furthermore, it is contemplated that a particular feature described, either individually or as part of an aspect, can be combined with other individually described features, or parts of other aspects. Thus, absence of describing combinations should not preclude the inventor(s) from claiming rights to such combinations.

What is claimed is:

1. A method of provisioning data in a node cluster, the method comprising:
monitoring data access requests received by a first node of the node cluster, wherein the data access requests correspond with operations to be performed on a data volume stored on a second node of the node cluster;
determining that a number of the data access requests received by the first node satisfies a first threshold amount;
upon determining that the number of data access requests satisfies the first threshold amount, selectively provisioning a cache to store a copy of the data volume on the first node based, at least in part, on a system load of the first node.

2. The method of claim 1, wherein the first threshold amount corresponds to a threshold percentage of the data access requests representing read operations, and wherein determining that the number of data access requests satisfies the first threshold amount comprises:
determining that at least 95% of the data access requests received by the first node, during a predetermined period, represent read operations.

3. The method of claim 1, wherein the system load includes an amount of processor headroom available for the first node, and wherein selectively provisioning the cache comprises:
provisioning the cache if the amount of processor headroom exceeds a first threshold.

4. The method of claim 3, wherein the system load further includes an amount of aggregate headroom available for each aggregate associated with the first node, and wherein provisioning the cache comprises:
selecting an aggregate on the first node to host the cache based on the amount of aggregate headroom available for each aggregate associated with the first node.

5. The method of claim 1, wherein selectively provisioning the cache comprises:
detecting a first cache request from the second node, wherein the first cache request indicates that the data volume is causing a system load of the second node to exceed a threshold load amount; and
selectively provisioning the cache in response to detecting the first cache request.

6. The method of claim 5, wherein the first cache request further indicates a number of data access requests received by the second node that are associated with the data volume stored on the second node, and wherein selectively provisioning the cache further comprises:
determining whether the number of data access requests received by the second node exceeds the number of data access requests received by the first node over a given period; and
selectively provisioning the cache upon determining that the number of data access requests received by the second node exceeds the number of data access requests received by the first node.

7. The method of claim 1, further comprising:
detecting an updated system load of the second node, after provisioning the cache on the first node; and
de-provisioning the cache if, based on the updated system load, less than 80% of the data access requests received by the first node represent read operations.

8. The method of claim 1, further comprising:
detecting a second cache request from the second node, wherein the second cache request indicates that another data volume is causing a system load of the second node to exceed a threshold load amount; and
de-provisioning the cache to enable a new cache to be provisioned for the other data volume.

9. A data storage system comprising:
a memory containing machine readable medium comprising machine executable code having stored thereon;
a processing module, coupled to the memory, to execute the machine executable code to:
monitor data access requests received by a first node, wherein the data access requests correspond with operations to be performed on a data volume stored on a second node;
determine that a number of the data access requests received by the first node satisfies a first threshold amount; and
upon determining that the first threshold amount is satisfied, selectively provision a cache to store a copy of the data volume on the first node based, at least in part, on a system load of the first node.

10. The system of claim 9, wherein the first threshold amount corresponds to a threshold percentage of the data access requests representing read operations, and wherein the processing module is to determine that the number of data access requests satisfies the first threshold amount by:
determining that at least 95% of the data access requests received by the first node, during a predetermined period, represent read operations.

11. The system of claim 9, wherein the system load includes an amount of processor headroom available for the first node, and wherein the processing module is to provision the cache if the amount of processor headroom exceeds a first threshold.

12. The system of claim 9, wherein the processing module is to selectively provision the cache by:
detecting a first cache request from the second node, wherein the first cache request indicates that the data volume is causing a system load of the second node to exceed a threshold load amount; and
selectively provisioning the cache in response to detecting the first cache request.

13. The system of claim 9, wherein the processing module is to further:
detect an updated system load of the second node, after provisioning the cache on the first node; and
de-provision the cache if, based on the updated system load, less than 80% of the data access requests received by the first node represent read operations.

14. The system of claim 9, wherein the processing module is to further:
detect a second cache request from the second node, wherein the second cache request indicates that another data volume is causing a system load of the second node to exceed a threshold load amount; and
de-provision the cache to enable a new cache to be provisioned for the other data volume.

15. A computer-readable medium for implementing data provisioning in a node cluster, the computer-readable medium storing instructions that, when executed by one or more processors, cause the one or more processors to perform operations comprising:
monitoring data access requests received by a first node of the node cluster, wherein the data access requests correspond with operations to be performed on a data volume stored on a second node of the node cluster;
determining that a number of the data access requests received by the first node satisfies a first threshold amount;
upon determining that the first threshold amount is satisfied, selectively provisioning a cache to store a copy of the data volume on the first node based, at least in part, on a system load of the first node.

16. The computer-readable medium of claim 15, wherein the first threshold amount corresponds to a threshold percentage of the data access requests representing read operations, and wherein the instructions for determining that the number of data access requests satisfies the first threshold amount include instructions for:
determining that at least 95% of the data access requests received by the first node, during a predetermined period, represent read operations.

17. The computer-readable medium of claim 15, wherein the system load includes an amount of processor headroom available for the first node, and wherein the instructions for selectively provisioning the cache include instructions for:
provisioning the cache if the amount of processor headroom exceeds a first threshold.

18. The computer-readable medium of claim 15, wherein the instructions for selectively provisioning the cache include instructions for:
detecting a first cache request from the second node, wherein the first cache request indicates that the data volume is causing a system load of the second node to exceed a threshold load amount; and
selectively provisioning the cache in response to detecting the first cache request.

19. The computer-readable medium of claim 15, further comprising instructions for:
detecting an updated system load of the second node, after provisioning the cache on the first node; and
de-provisioning the cache if, based on the updated system load, less than 80% of the data access requests received by the first node represent read operations.

20. The computer-readable medium of claim 15, further comprising instructions for:
detecting a second cache request from the second node, wherein the second cache request indicates that another data volume is causing a system load of the second node to exceed a threshold load amount; and
de-provisioning the cache to enable a new cache to be provisioned for the other data volume.
